(19) United States
(12) Patent Application Publication
(10) Pub. No.: US 2021/0357243 A1
(43) Pub. Date: Nov. 18, 2021

(54) VIRTUAL DESKTOP CONTROLLING METHOD

(71) Applicant: Primax Electronics Ltd., Taipei (TW)

(72) Inventors: Che-Yen Huang, Taipei (TW); Ying-Che Tseng, Taipei (TW); Shi-Jie Zhang, Taipei (TW)

(21) Appl. No.: 16/911,199

(22) Filed: Jun. 24, 2020

(30) Foreign Application Priority Data
May 15, 2020 (TW) 109116272

(51) Int. Cl. G06F 9/455; G06F 3/0489; G06F 9/451

(52) U.S. Cl. CPC G06F 9/45558; G06F 2009/45575; G06F 9/452; G06F 3/04892

(57) ABSTRACT

A desktop controlling method is provided. The desktop switching function is selectively enabled according to the result of detecting whether a cursor is located at a border of the current desktop and the result of detecting whether a desktop switching signal. Consequently, the desktop switching function can be achieved through the mouse only. That is, it is not necessary to operate both of the mouse and the keyboard to achieve the desktop switching function. Moreover, the background colors of the virtual desktops can be set by the user according to the practical requirements. Consequently, the virtual keyboard to be switched can be easily recognized by the user.

### FIELD OF THE INVENTION

The present invention relates to a controlling method, and more particularly to a virtual desktop controlling method.

### BACKGROUND OF THE INVENTION

Computer systems are important tools for modern people. For example, the computer system can be used in a word processing application, a video playback application, a drawing application, a programming application, and so on. Generally, the computer system is connected with a mouse and a keyboard. The user may operate the mouse and the keyboard to control the computer system. With the increasing development of science and technology, the computer system and the peripheral device are improved. Moreover, an operating system installed in the computer system provides many new functions for facilitating the user to operate the control system.

For example, some operating systems provide the virtual desktop functions. The operating system provides a main desktop and a virtual desktop. The default desktop under the operating system is the main desktop. In response to an input command, the virtual desktop is enabled. The user can execute specific software on the virtual desktop. For example, the user can open software such as the word processing software on the main desktop, and the user can open social software on the virtual desktop. When the user wants to concentrate on the office, the user can do associate work on the main desktop. When the user wants to talk with friends, the user can switch the current desktop to the virtual desktop. The software opened on the main desktop will not be shown on the virtual desktop. The software opened on the virtual desktop will not be shown on the main desktop. Since the virtual desktop has the function of classifying software components, the operating efficacy is enhanced.

Take the operating system Win 10 for example. The user may operate combination keys to perform associated operations. For example, when the Win key, the Ctrl key and the D key are pressed down simultaneously, the operating system Win 10 newly adds a virtual desktop. When the Win key and the key and the Tab are pressed down simultaneously, the operating system Win 10 displays all virtual desktops for preview. When the Win key, the Ctrl key and the right arrow key are pressed down simultaneously, the operating system Win 10 switches the current desktop to the next virtual desktop. When the Win key, the Ctrl key and the left arrow key are pressed down simultaneously, the operating system Win 10 switches the current desktop to the previous virtual desktop.

As mentioned above, since the conventional method of operating the virtual desktop is implemented through the input of the combination key, the user has to simultaneously operate the keyboard and the mouse to operate the virtual desktop. That is, the user is unable to operate the virtual desktop through the mouse only. Moreover, since the backgrounds of the virtual desktop and the main desktop are identical, it is difficult for to user to discriminate the main desktop from the virtual desktop at a glance.

Therefore, there is a need of providing a virtual desktop controlling method for allowing the user to operate the virtual desktop with a mouse only.

### SUMMARY OF THE INVENTION

An object of the present invention provides a virtual desktop controlling method for allowing the user to operate the virtual desktop with a mouse only.

In accordance with an aspect of the present invention, a virtual desktop controlling method for a computer system is provided. The virtual desktop controlling method includes steps of: (A) detecting whether a cursor movement signal is received, (B) detecting whether a desktop switching signal is received, (C) judging whether a virtual desktop number in the computer system is equal to 1, (D) judging whether a cursor of the computer system is located at a border of a current desktop of the computer system, (E) judging whether a virtual desktop corresponding to the border has been created, (F) configuring virtual desktop settings, so that at least one virtual desktop is created, and switching the current desktop of the computer system.

In accordance with another aspect of the present invention, a virtual desktop controlling method for a computer system is provided. The virtual desktop controlling method includes steps of: (A) detecting whether a cursor movement signal is received, (B) detecting whether a desktop switching signal is received, (C) judging whether a virtual desktop number in the computer system is equal to 0, equal to 1 or larger than 1, (D*) allowing plural thumbnails corresponding to plural virtual desktops to be displayed at a location near a cursor of the computer system, (E*) detecting whether a selecting signal is received, (F) configuring virtual desktop settings, so that at least one virtual desktop is created, and (G) switching a current desktop of the computer system.

In accordance with another aspect of the present invention, a virtual desktop controlling method for a computer system is provided. The virtual desktop controlling method includes steps of: (A) detecting whether a cursor movement signal is received, (B) detecting whether a desktop switching signal is received, (C) judging whether a virtual desktop number in the computer system is equal to 0, equal to 1 or larger than 1, (D) judging whether a cursor of the computer system is located at a border of a current desktop of the computer system, (D*) allowing plural thumbnails corresponding to plural virtual desktops to be displayed at a location near a cursor of the computer system, (E) judging whether a virtual desktop corresponding to the border has been created, (E*) detecting whether a selecting signal is received, (F) configuring virtual desktop settings, so that at least one virtual desktop is created, and (G) switching the current desktop of the computer system.

From the above descriptions, the present invention provides various virtual desktop controlling methods of the present for allowing the user to create plural virtual desktops according to the usual habit of the user. In addition, the desktop switching function can be achieved through the mouse only. That is, it is not necessary to operate both of the mouse and the keyboard to achieve the desktop switching function. Moreover, the background colors of the virtual desktops can be set by the user according to the practical requirements. Consequently, the virtual keyboard to be switched can be easily recognized by the user at a glance.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic functional block diagram illustrating a computer system using a virtual desktop controlling method according to an embodiment of the present invention;

FIG. 2 is a flowchart illustrating a virtual desktop controlling method according to a first embodiment of the present invention;

FIG. 3 schematically illustrates a thumbnail corresponding to a virtual desktop on a display screen of the computer system using the virtual desktop controlling method of the first embodiment;

FIG. 4 is a flowchart illustrating a virtual desktop controlling method according to a second embodiment of the present invention;

FIG. 5 schematically illustrates a thumbnail corresponding to a virtual desktop on a display screen of the computer system using the virtual desktop controlling method of the second embodiment; and

FIGS. 6A and 6B illustrate a flowchart of a virtual desktop controlling method according to a third embodiment of the present invention.

### DETAILED DESCRIPTION OF THE PREFERRED EMBODIMENT

The present invention provides a virtual desktop controlling method in order to overcome the drawbacks of the conventional technologies. The embodiments of present invention will be described more specifically with reference to the following drawings. For well understanding the present invention, the elements shown in the drawings are not in scale with the elements of the practical product. In the following embodiments and drawings, the elements irrelevant to the concepts of the present invention or the elements well known to those skilled in the art are omitted. It is noted that numerous modifications and alterations may be made while retaining the teachings of the invention.

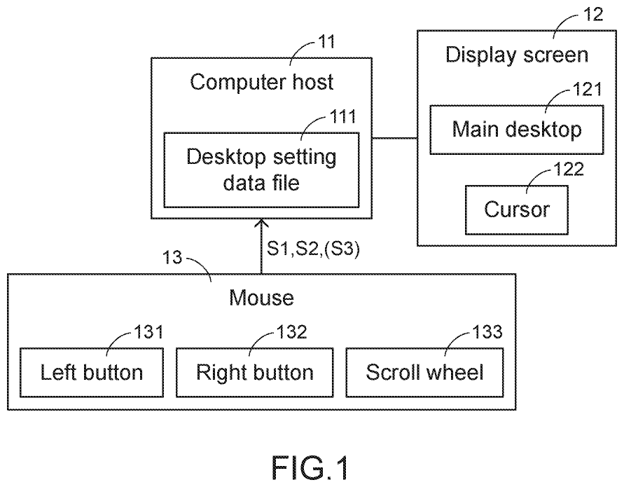

Hereinafter, a computer system using a virtual desktop controlling method of the present invention will be described as follows. FIG. 1 is a schematic functional block diagram illustrating a computer system using a virtual desktop controlling method according to an embodiment of the present invention. The computer system 1 comprises a computer host 11, a display screen 12 and a mouse 13. The computer host 11 is connected with the mouse 13 and the display screen 12. The computer host 11 is connected with the mouse 13 in a wireless communication manner or a wired communication manner. A default main desktop 121 and a cursor 122 are shown on the display screen 12. The user may operate the mouse 13 to control the movement or the operation of the cursor 122. Consequently, the computer host 11 executes a corresponding command. The mouse 13 comprises a left button 131, a right button 132 and a scroll wheel 133. The components of the mouse 13 are well known to those skilled in the art, and not redundantly described herein. According to the user's settings, the computer host 11 create a corresponding virtual desktop (not shown), and the current desktop shown on the display screen 12 is switched from the main desktop 121 to the virtual desktop.

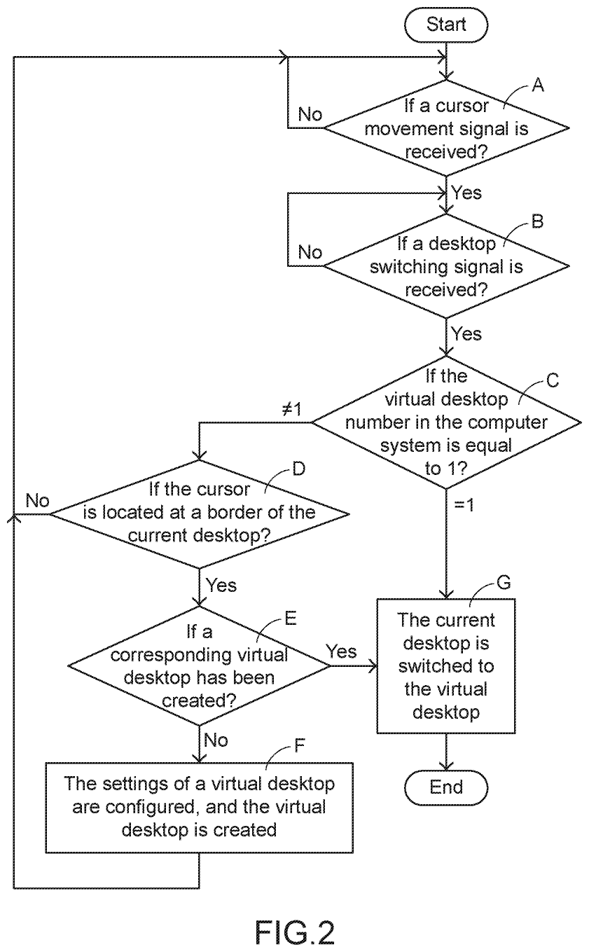

The virtual desktop controlling method of the present invention will be described with reference to FIGS. 1 and 2. FIG. 2 is a flowchart illustrating a virtual desktop controlling method according to a first embodiment of the present invention. The virtual desktop controlling method comprises the following steps.

In a step A, the computer host detects whether a cursor movement signal is received.

In a step B, the computer host detects whether a desktop switching signal is received.

In a step C, the computer host judges whether the virtual desktop number in the computer system is equal to 1 or not.

In a step D, the computer host judges whether the cursor is located at a border of the current desktop.

In a step E, the computer host judges whether a corresponding virtual desktop has been created.

In a step F, the settings of a virtual desktop are configured, and the virtual desktop is created.

In a step G, the current desktop is switched to the virtual desktop.

If the computer host 11 detects that the cursor movement signal S1 is received in the step A, the computer host 11 performs the step B. Whereas, if the computer host 11 does not detect the cursor movement signal S1 in the step A, the computer host 11 performs the step A again. If the computer host 11 detects that the desktop switching signal S2 is received in the step B, the computer host 11 performs the step C. Whereas, if the computer host 11 does not detect the desktop switching signal S2 in the step B, the computer host 11 performs the step B again. If the computer host 11 judges that the virtual desktop number in the computer system is equal to 1 in the step C, the computer host 11 performs the step G. Whereas, if the computer host 11 judges that the virtual desktop number in the computer system is not equal to 1 in the step C, the computer host 11 performs the step D.

If the computer host 11 judges that the cursor 122 is located at a border 123 of the current desktop in the step D, the computer host 11 performs the step E. Whereas, if the computer host 11 judges that the cursor 122 is not located at the border 123 of the current desktop in the step D, the computer host 11 performs the step A again. If the computer host 11 judges that a virtual desktop corresponding to the border 123 has been created in the step E, the computer host 11 performs the step G. Whereas, if the computer host 11 judges that no virtual desktop corresponding to the border 123 has been created in the step E, the computer host 11 performs the step F. After the step F is completed, the step A is performed again. After the step G is completed, the virtual desktop controlling method is ended.

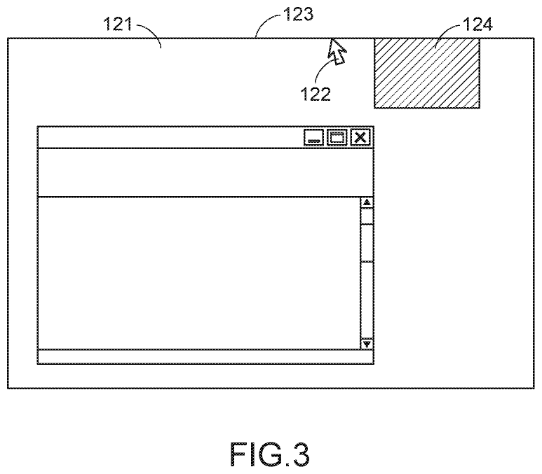

Hereinafter, the operations of the virtual desktop controlling method will be described with reference to FIGS. 1, 2 and 3. FIG. 3 schematically illustrates a thumbnail corresponding to a virtual desktop on a display screen of the computer system using the virtual desktop controlling method of the first embodiment. It is assumed that no virtual desktop has been created by the computer host 11. Consequently, the main desktop is shown on the display screen 12 under control of the computer host 11. When the mouse 13 is used to control the computer system 1, the computer system 1 starts to perform the virtual desktop controlling method.

Firstly, the computer host 11 performs the step A to detect whether the cursor movement signal S1 is received. Then, the mouse 13 is moved and the mouse 13 is operated to output the desktop switching signal S2. According to a setting, the desktop switching signal S2 is generated when the scroll wheel 133 is pressed down. In the step A, the computer host 11 detects that the cursor movement signal S1 is received. Consequently, the cursor 122 is moved in response to the movement of the mouse 13. If the computer host 11 detects that the desktop switching signal S2 is received in the step B, the computer host 11 performs the step C. Since no virtual desktop has been created in the computer host 11, the computer host 11 judges that the virtual desktop number in the computer system is not equal to 1. Then, the step D is performed.

If the computer host 11 judges that the cursor 122 is not located at the border 123 of the current desktop in the step D, the computer host 11 performs the step A again. As shown in FIG. 3, the cursor 122 is moved to the border 123 of the main desktop 121 (e.g., the border 123 at the top side). Since the computer host 11 judges that the cursor 122 is located at the border 123 of the current desktop (i.e., the main desktop 121) in the step D, the computer host 11 performs the step E. Since no virtual desktop has been created so far, the computer host 11 judges that no virtual desktop corresponding to the border 123 at the top side has been created in the step E. Then, the computer host 11 performs the step F to configure a virtual desktop and create the virtual desktop. At the same time, a virtual desktop setting interface is shown by the computer host 11. The setting interface may be designed according to the practical requirements. The contents and associated information are well known to those skilled in the art, and not redundantly described herein.

In an embodiment, the setting interface provides a function of allowing the user to select a background color. According to the preference or the requirement of the user, the user may configure virtual desktops with different background colors. Due to the different background colors, the differences between different virtual desktop can be recognized by the user at a glance. For example, the virtual desktops corresponding to different borders 123 may be configured according to the following settings. Firstly, the virtual desktop corresponding to the border 123 at the right side is specially used for performing the word processing task, and the background color of the virtual desktop is red. Secondly, the virtual desktop corresponding to the border 123 at the top side is specially used for audio-visual entertainment, and the background color of the virtual desktop is yellow. Thirdly, the virtual desktop corresponding to the border 123 at the bottom side is specially used for performing the programming task, and the background color of the virtual desktop is blue. Fourthly, the virtual desktop corresponding to the border 123 at the left side is specially used for community chart, and the background color of the virtual desktop is green. According to the background color, the user can easily recognize the use of each virtual desktop at a glance. Consequently, the user can change the current desktop to the desired virtual desktop. After the virtual desktops are configured, the associated setting data are stored in a desktop setting data file 111 of the computer host 11. Then, the step A is performed again.

Then, the cursor 122 is moved to the border 123 at the top side of the main desktop 121. The computer host 11 performs the step A, the step B, the step C, the step D, the step E and the step G sequentially. Consequently, the current desktop of the computer system 1 is changed to the virtual desktop corresponding to the border 123 at the top side. Meanwhile, the virtual desktop controlling method is completed.

Moreover, when the cursor 122 is moved to the border 123 at the top side of the main desktop 121, the computer host 122 judges that the cursor 122 is located at the border 123 at the top side of the main desktop 121 in the step D. Consequently, a thumbnail 124 corresponding to the virtual desktop is shown on the main desktop 121 so as to be clicked and selected by the user.

The following three aspects should be specially described.

Firstly, if only one virtual desktop is created in the step F, the operation of the virtual desktop controlling method is simplified. For example, after the user operates the mouse 13 to generate the desktop switching signal S2, the computer hot 11 performs the step A, the step B, the step C and the step G sequentially. Consequently, the current desktop of the computer system 1 is changed to the virtual desktop. In other words, it is not necessary to move the cursor 122 to the border 123.

Secondly, the virtual desktop number corresponding to each border 123 is not restricted to 1. That is, the virtual desktop number corresponding to each border is more than 1 according to the practical requirements. For example, two virtual desktops corresponding to the border 123 at the right side are created. If the computer host 122 judges that the cursor 122 is located at the border 123 at the right side of the main desktop 121 in the step D, the thumbnails corresponding to the two virtual desktops are shown on the main desktop 121 so as to be selected by the user. After one thumbnail is selected, the current desktop of the computer system 1 is changed to the selected virtual desktop by the computer host 11.

Thirdly, the method of generating the desktop switching signal S2 is not restricted. In the above embodiment, the desktop switching signal S2 is generated when the scroll wheel is pressed down. In another embodiment, the desktop switching signal is generated when plural buttons of the mouse are pressed down, when a specified mouse gesture is detected or when a specified button of the mouse is pressed down and a specified mouse gesture is detected. In some other embodiments, a keyboard and/or the mouse are operated to generate the desktop switching signal. For example, the desktop switching signal is generated when a specified key of the keyboard is pressed down, when a specified key of the keyboard and a specified button of the mouse are pressed down or when a specified key of the keyboard is pressed down and a specified mouse gesture is detected. Although the method of operating both of the keyboard and the mouse to generate the desktop switching signal is complicated, the possibility of erroneously generating the desktop switching signal is minimized.

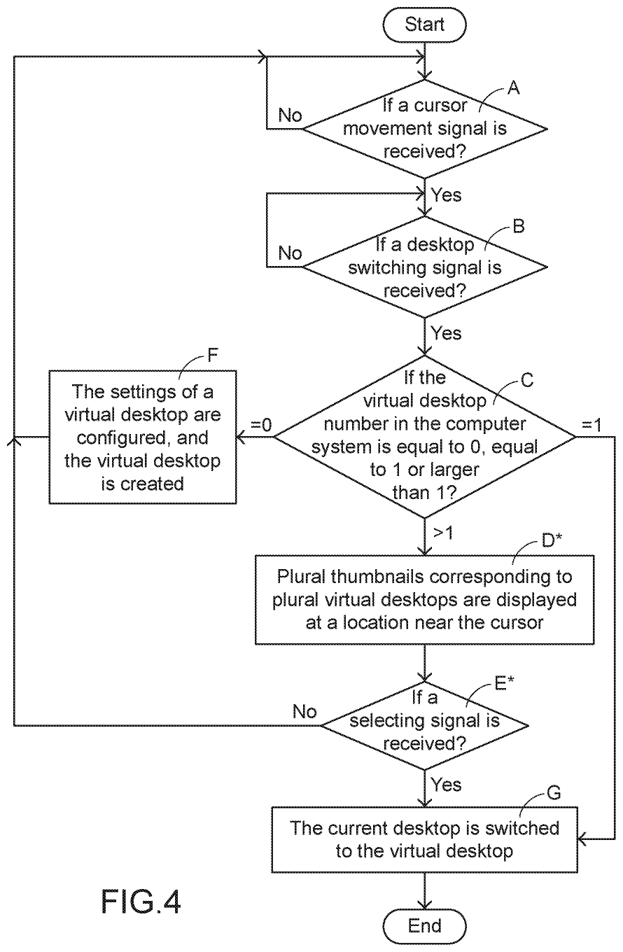

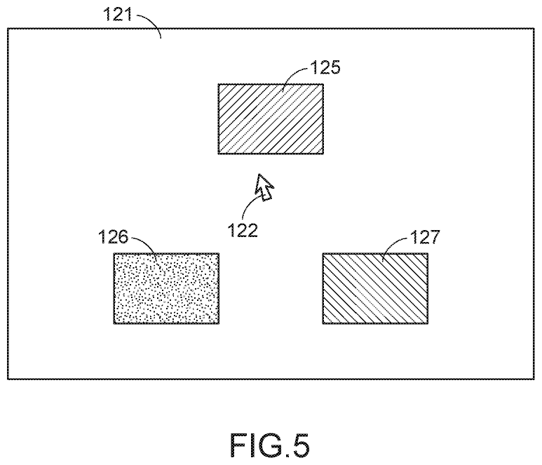

The present invention further provides a second embodiment of the virtual desktop controlling method, which is distinguished from the first embodiment. FIG. 4 is a flowchart illustrating a virtual desktop controlling method according to a second embodiment of the present invention. FIG. 5 schematically illustrates a thumbnail corresponding to a virtual desktop on a display screen of the computer system using the virtual desktop controlling method of the second embodiment. Please refer to FIGS. 1, 4 and 5. The virtual desktop controlling method of this embodiment comprises the following steps.

In a step A, the computer host detects whether a cursor movement signal is received.

In a step B, the computer host detects whether a desktop switching signal is received.

In a step C, the computer host judges whether the virtual desktop number in the computer system is equal to 0, equal to 1 or larger than 1.

In a step D*, plural thumbnails corresponding to plural virtual desktops are displayed at a location near the cursor.

In a step E*, the computer host detects whether a selecting signal is received.

In a step F, the settings of a virtual desktop are configured, and the virtual desktop is created.

In a step G, the current desktop is switched to the virtual desktop.

If the computer host 11 detects that the cursor movement signal S1 is received in the step A, the computer host 11 performs the step B. Whereas, if the computer host 11 does not detect the cursor movement signal S1 in the step A, the computer host 11 performs the step A again. If the computer host 11 detects that the desktop switching signal S2 is received in the step B, the computer host 11 performs the step C. Whereas, if the computer host 11 does not detect the desktop switching signal S2 in the step B, the computer host 11 performs the step B again. If the computer host 11 judges that the virtual desktop number in the computer system is equal to 1 in the step C, the computer host 11 performs the step G. If the computer host 11 judges that the virtual desktop number in the computer system is equal to 0 in the step C, the computer host 11 performs the step F. Whereas, if the computer host 11 judges that the virtual desktop number in the computer system is larger than 1 in the step C, the computer host 11 performs the step D*. If the computer host 11 judges that the selecting signal S3 is received in the step E*, the computer host 11 performs the step G. Whereas, if the selecting signal S3 has not been received for a specified time period in the step E*, the step A is performed again.

For well understanding the virtual desktop controlling method of this embodiment, three usage scenarios will be described as follows.

In a first usage scenario, no virtual desktop has not been created by the user. When the mouse 13 is operated to move the cursor and generate the desktop switching signal, the computer host 11 performs the step A, the step B, the step C and the step F sequentially to create the virtual desktop.

In a second usage scenario, one virtual desktop has been created by the user. When the mouse 13 is operated to move the cursor and generate the desktop switching signal, the computer host 11 performs the step A, the step B, the step C and the step G sequentially. Consequently, the current desktop is switched to the virtual desktop. The operation of this usage scenario is similar to the operation of the first embodiment with one virtual desktop.

In a third usage scenario, plural virtual desktops have been created by the user. When the mouse 13 is operated to move the cursor and generate the desktop switching signal, the computer host 11 performs the step A, the step B, the step C, the step D*, the step E* and the step G sequentially. Consequently, the current desktop is switched to the desired virtual desktop. In the step D*, plural thumbnails 125, 126 and 127 corresponding to the plural virtual desktops are displayed at the location near the cursor 122 by the computer host 11 (see FIG. 5). According to the practical requirements, the user may select one of the thumbnails 125, 126 and 127. Consequently, a corresponding selecting signal S3 is generated. According to the selecting signal S3, the computer host 11 realizes the thumbnail that is selected by the user in the step E*. Consequently, the current desktop is switched to the selected virtual desktop in the step G.

The virtual desktop controlling method of this embodiment is advantageous. The function of switching the virtual desktop can be achieved without the need of moving the cursor 122 to the border of the current desktop.

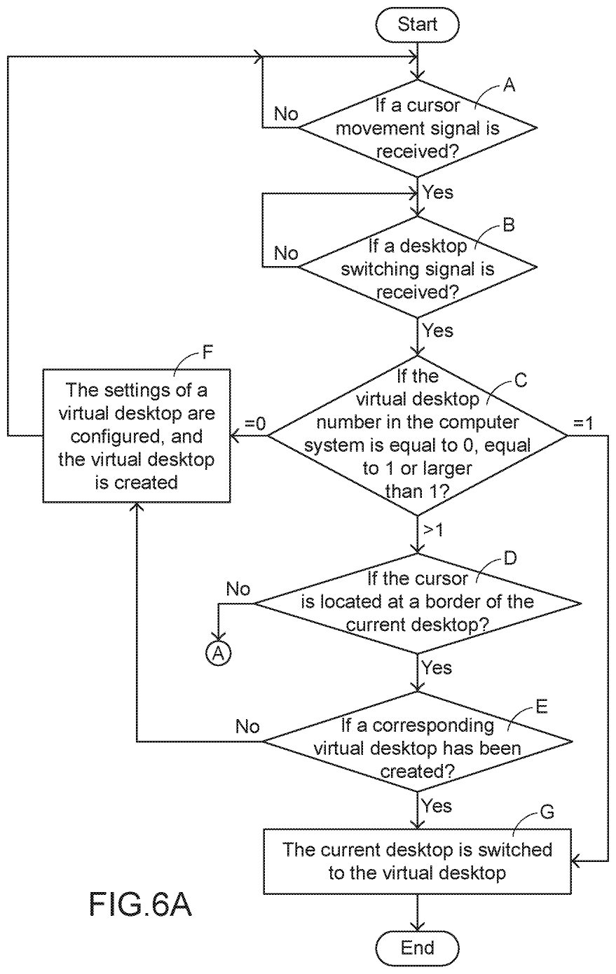

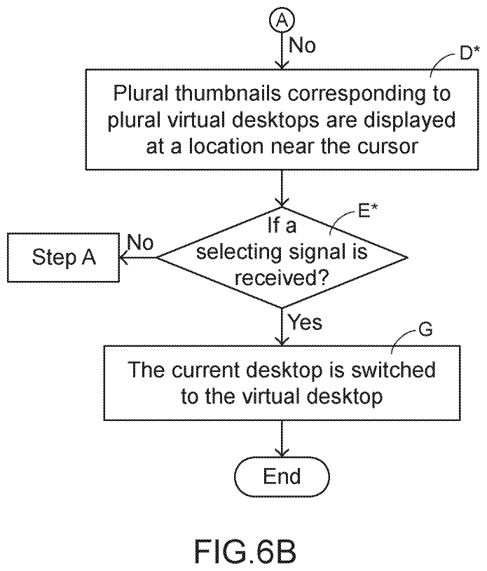

The present invention further provides a third embodiment of the virtual desktop controlling method, which is distinguished from the above embodiments. FIGS. 6A and 6B illustrate a flowchart of a virtual desktop controlling method according to a third embodiment of the present invention. Please refer to FIGS. 1, 6A and 6B. The virtual desktop controlling method of this embodiment comprises the following steps.

In a step A, the computer host detects whether a cursor movement signal is received.

In a step B, the computer host detects whether a desktop switching signal is received.

In a step C, the computer host judges whether the virtual desktop number in the computer system is equal to 0, equal to 1 or larger than 1.

In a step D, the computer host judges whether the cursor is located at a border of the current desktop.

In a step D*, plural thumbnails corresponding to plural virtual desktops are displayed at a location near the cursor.

In a step E, the computer host judges whether a corresponding virtual desktop has been created.

In a step E*, the computer host detects whether a selecting signal is received.

In a step F, the settings of a virtual desktop are configured, and the virtual desktop is created.

In a step G, the current desktop is switched to the virtual desktop.

If the computer host 11 detects that the cursor movement signal S1 is received in the step A, the computer host 11 performs the step B. Whereas, if the computer host 11 does not detect the cursor movement signal S1 in the step A, the computer host 11 performs the step A again. If the computer host 11 detects that the desktop switching signal S2 is received in the step B, the computer host 11 performs the step C. Whereas, if the computer host 11 does not detect the desktop switching signal S2 in the step B, the computer host 11 performs the step B again. If the computer host 11 judges that the virtual desktop number in the computer system is equal to 1 in the step C, the computer host 11 performs the step G. If the computer host 11 judges that the virtual desktop number in the computer system is equal to 0 in the step C, the computer host 11 performs the step F. Whereas, if the computer host 11 judges that the virtual desktop number in the computer system is larger than 1 in the step C, the computer host 11 performs the step D.

If the computer host 11 judges that the selecting signal S3 is received in the step E*, the computer host 11 performs the step G. Whereas, if the selecting signal S3 has not been received for a specified time period in the step E*, the step A is performed again. If the computer host 11 judges that the cursor 122 is located at a border 123 of the current desktop in the step D, the computer host 11 performs the step E. Whereas, if the computer host 11 judges that the cursor 122 is not located at the border 123 of the current desktop in the step D, the computer host 11 performs the step D*. If the computer host 11 judges that the virtual desktop corresponding to the border 123 have been created in the step E, the computer host 11 performs the step G. Whereas, if the computer host 11 judges that no virtual desktop corresponding to the border 123 has been created in the step E, the computer host 11 performs the step F. After the step F is completed, the step A is performed again. After the step G is completed, the virtual desktop controlling method is ended.

The virtual desktop controlling method of this embodiment includes the steps of the first embodiment and the second embodiment. Consequently, the user can select one of two switching approaches according to the practical requirements. In accordance with the first approach, the cursor 122 is moved to the border 123. In accordance with the second approach, the plural thumbnails corresponding to plural virtual desktops are displayed at the location near the cursor 11. Consequently, the desktop switching function can be easily achieved through the mouse only.

From the above descriptions, the present invention provides various virtual desktop controlling methods of the present for allowing the user to create plural virtual desktops according to the usual habit of the user. In addition, the desktop switching function can be achieved through the mouse only. That is, it is not necessary to operate both of the mouse and the keyboard to achieve the desktop switching function. Moreover, the background colors of the virtual desktops can be set by the user according to the practical requirements. Consequently, the virtual keyboard to be switched can be easily recognized by the user at a glance. When the virtual desktop controlling method of the present invention is applied to small thumbnails, the benefits are more obvious.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A virtual desktop controlling method for a computer system, the virtual desktop controlling method comprising steps of:
(A) detecting whether a cursor movement signal is received;
(B) detecting whether a desktop switching signal is received;
(C) judging whether a virtual desktop number in the computer system is equal to 1;
(D) judging whether a cursor of the computer system is located at a border of a current desktop of the computer system;
(E) judging whether a virtual desktop corresponding to the border has been created;
(F) configuring virtual desktop settings, so that at least one virtual desktop is created; and
(G) switching the current desktop of the computer system.

2. The virtual desktop controlling method according to claim 1, wherein if a detecting result of the step (A) indicates that the cursor movement signal is received, the step (B) is performed, wherein the detecting result of the step (A) indicates that the cursor movement signal is not received, the step (A) is performed again, wherein if a detecting result of the step (B) indicates that the desktop switching signal is received, the step (C) is performed, wherein if the detecting result of the step (B) indicates that the desktop switching signal is not received, the step (B) is performed again.

3. The virtual desktop controlling method according to claim 1, wherein if a detecting result of the step (C) indicates that the virtual desktop number in the computer system is equal to 1, the step (G) is performed, wherein if the detecting result of the step (C) indicates that the virtual desktop number in the computer system is not equal to 1, the step (D) is performed, wherein if a detecting result of the step (D) indicates that the cursor is located at the border of the current desktop, the step (E) is performed, wherein if the detecting result of the step (D) indicates that the cursor is not located at the border of the current desktop, the step (A) is performed again, wherein if a detecting result of the step (E) indicates that the virtual desktop corresponding to the border has been created, the step (G) is performed, wherein if the detecting result of the step (E) indicates that the virtual desktop corresponding to the border has not been created, the step (F) is performed.

4. A virtual desktop controlling method for a computer system, the virtual desktop controlling method comprising steps of:
(A) detecting whether a cursor movement signal is received;
(B) detecting whether a desktop switching signal is received;
(C) judging whether a virtual desktop number in the computer system is equal to 0, equal to 1 or larger than 1;
(D*) allowing plural thumbnails corresponding to plural virtual desktops to be displayed at a location near a cursor of the computer system;
(E*) detecting whether a selecting signal is received;
(F) configuring virtual desktop settings, so that at least one virtual desktop is created; and
(G) switching a current desktop of the computer system.

5. The virtual desktop controlling method according to claim 4, wherein if a detecting result of the step (A) indicates that the cursor movement signal is received, the step (B) is performed, wherein the detecting result of the step (A) indicates that the cursor movement signal is not received, the step (A) is performed again, wherein if a detecting result of the step (B) indicates that the desktop switching signal is received, the step (C) is performed, wherein if the detecting result of the step (B) indicates that the desktop switching signal is not received, the step (B) is performed again.

6. The virtual desktop controlling method according to claim 4, wherein if a detecting result of the step (C) indicates that the virtual desktop number in the computer system is equal to 1, the step (G) is performed, wherein if the detecting result of the step (C) indicates that the virtual desktop number in the computer system is equal to 0, the step (F) is performed, wherein if the detecting result of the step (C) indicates that the virtual desktop number in the computer system is larger than 1, the step (D*) is performed.

7. The virtual desktop controlling method according to claim 4, wherein if a detecting result of the step (E*) indicates that the selecting signal is received, a thumbnail of the plural thumbnails is selected according to the selecting signal and the step (G) is performed to switch the current desktop to the virtual desktop corresponding to the selected thumbnail, wherein if the detecting result of the step (E*) indicates that the selecting signal is not received, the step (A) is performed again.

9. A virtual desktop controlling method for a computer system, the virtual desktop controlling method comprising steps of:
(A) detecting whether a cursor movement signal is received;
(B) detecting whether a desktop switching signal is received;
(C) judging whether a virtual desktop number in the computer system is equal to 0, equal to 1 or larger than 1;
(D) judging whether a cursor of the computer system is located at a border of a current desktop of the computer system;
(D*) allowing plural thumbnails corresponding to plural virtual desktops to be displayed at a location near a cursor of the computer system;
(E) judging whether a virtual desktop corresponding to the border has been created;
(E*) detecting whether a selecting signal is received;
(F) configuring virtual desktop settings, so that at least one virtual desktop is created; and
(G) switching the current desktop of the computer system.

9. The virtual desktop controlling method according to claim 8, wherein if a detecting result of the step (A) indicates that the cursor movement signal is received, the step (B) is performed, wherein the detecting result of the step (A) indicates that the cursor movement signal is not received, the step (A) is performed again, wherein if a detecting result of the step (B) indicates that the desktop switching signal is received, the step (C) is performed, wherein if the detecting result of the step (B) indicates that the desktop switching signal is not received, the step (B) is performed again.

10. The virtual desktop controlling method according to claim 8, wherein if a detecting result of the step (C) indicates that the virtual desktop number in the computer system is equal to 1, the step (G) is performed, wherein if the detecting result of the step (C) indicates that the virtual desktop number in the computer system is equal to 0, the step (F) is performed, wherein if the detecting result of the step (C) indicates that the virtual desktop number in the computer system is larger than 1, the step (D) is performed, wherein if a detecting result of the step (D) indicates that the cursor is located at the border of the current desktop, the step (E) is performed, wherein if the detecting result of the step (D) indicates that the cursor is not located at the border of the current desktop, the step (D*) is performed.

11. The virtual desktop controlling method according to claim 8, wherein if a detecting result of the step (E) indicates that the virtual desktop corresponding to the border has been created, the step (G) is performed, wherein if the detecting result of the step (E) indicates that the virtual desktop corresponding to the border has not been created, the step (F) is performed, wherein if a detecting result of the step (E*) indicates that the selecting signal is received, a thumbnail of the plural thumbnails is selected according to the selecting signal and the step (G) is performed to switch the current desktop to the virtual desktop corresponding to the selected thumbnail, wherein if the detecting result of the step (E*) indicates that the selecting signal is not received, the step (A) is performed again.
